(19) United States
(12) Patent Application Publication
(10) Pub. No.: US 2008/0101640 A1
(43) Pub. Date: May 1, 2008

(54) Electroacoustic system and method of manufacturing thereof

(75) Inventors: William J. Ballad, Buffalo Grove, IL (US); Timothy K. Wickstrom, Elk Grove Village, IL (US); Gwendolyn P. Massingill, Aurora, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Knowles Electronics, LLC, Itasca, IL (US)

(21) Appl. No.: 11/590,698

(22) Filed: Oct. 31, 2006

(51) Int. Cl. H04R 1/02; H04R 1/20; G10K 11/00

(52) U.S. Cl. 381/338; 181/182

(57) ABSTRACT

An electroacoustic system includes a transducer having a front volume and a back volume. The transducer has a sound inlet port that is in communication with the front volume. An acoustic coupling is joined to the transducer. The acoustic coupling has a passageway comprising a first end and a second end. The second end is acoustically coupled to the sound inlet port for altering the peak frequency response of the transducer.

### BRIEF DESCRIPTION OF THE DRAWINGS

For a more complete understanding of the disclosure, reference should be made to the following detailed description and accompanying drawings wherein:

FIG. 1 is a perspective view of an acoustic coupling utilized in an electroacoustic system in accordance with an exemplary embodiment of the present invention;

FIG. 2 is a perspective view showing a bottom side view of the acoustic coupling of FIG. 1 in accordance with the exemplary embodiment of the present invention;

FIG. 3 is a cross sectional view of the electroacoustic system of FIG. 1 according to the present invention;

FIG. 4 is a bottom plan view of another embodiment of an acoustic coupling according to the present invention;

FIG. 5 is a partial exploded view of another described embodiment of an electroacoustic system according to the present invention; and

FIG. 6 is a graph showing the frequency response of an electroacoustic system according to the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

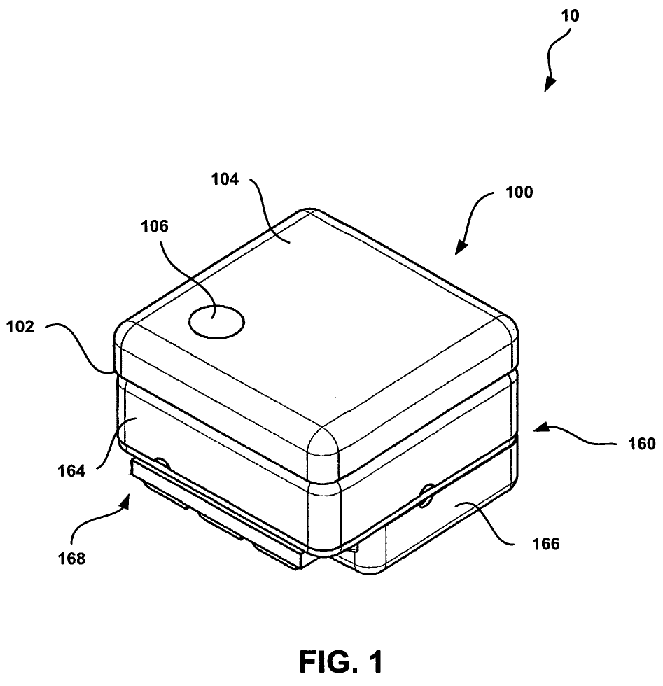

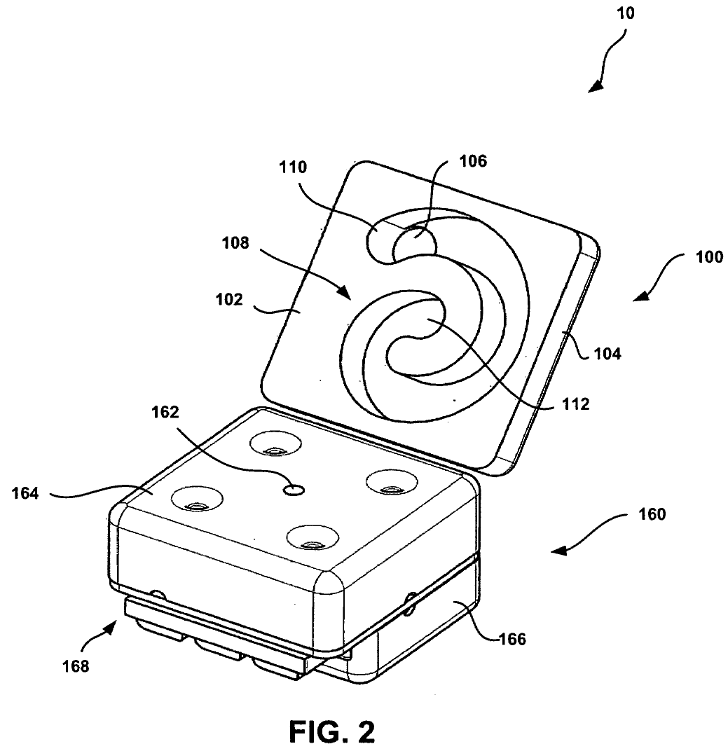

FIGS. 1-2 illustrate perspective views of an electroacoustic system 10. The system 10 may be employed in various types of electronic devices such as computers (e.g. desktops, laptops, notebooks, tablets, hand-held computers, Personal Digital Assistants (PDAs)), communication devices (e.g. cellular phones, web-enabled cellular telephones, cordless phones, pagers), computer-related peripherals (e.g. printers, scanners, monitors), entertainment devices (e.g. televisions, radios, stereos, tape and compact disc players, digital cameras, cameras, video cassette recorders, MP3 (Motion Picture Expert Group, Audio Layer 3) players), listening devices (e.g. hearing aids, earphones, headphones, Bluetooth wireless headsets, insert earphone) and the like, and other such devices such as hearing aids, in-ear monitors, and electronic hearing protection devices. The system 10 is usable to facilitate communications over one or more public or private communication networks of any type or operating according to any protocol.

The system 10 includes a transducer 160 and an acoustic coupling 100. The system 10 may include a single transducer 160 or two or more transducers, depending on the desired application. The transducer 160 may be a microphone, a receiver, a speaker, or any combination thereof.

In one example, the transducer 160 is a microphone. The transducer 160 comprises a base 164 and a cover 166, defining a housing 168. A sound inlet port 162 is formed in the base 164 enabling the acoustic waves to enter. The acoustic coupling 100 comprises a first surface 102 and a second surface 104. The acoustic coupling 100 may be manufactured from a variety of materials such as aluminum, stainless steel, plastic, and combination thereof and may take any form (having various scales, sizes, or dimensions) based upon the intended applications and operating conditions. In one example, the acoustic coupling 100 generally corresponds to and is joined to the base 164 of the transducer 160.

In addition, the shape of the acoustic coupling 100 may vary depending upon the intended application and operating conditions. For instance, the shape of the acoustic coupling 100 may be a roughly square shape, a cylindrical shape, a rectangular shape, or any other desired geometry.

An acoustic port 106 is formed in the second surface 104 and extends through the first surface 102 of the acoustic coupling 100 to direct the acoustic waves or sonic energy into the transducer 160 and will discussed in greater detail herein.

The acoustic coupling 100 further comprises a passageway 108 having a first end 110 and a second end 112. The passageway 108 is formed on the first surface 104 of the acoustic coupling 100 by stamping, or alternatively by other suitable methods, such as etching or molding. The passageway 108 can be manufactured in a variety of configurations such as, a spiral shape, a zig-zag shape, a curved shape, or a shape having any other desired geometry. The first end 110 of the passageway 108 is positioned adjacent to the acoustic port 106 and the second end 112 of the passageway 108 is positioned adjacent to the sound inlet port 162 of the transducer 160. In operation, the acoustic coupling 100 receives the sound energy through the acoustic port 106 and is then transmitted through the passageway 108, defining an acoustic path to the sound inlet port 162. Thereafter, the sound energy is transmitted to the working components of the transducer 160.

As shown, the passageway 108 is a spiral tube and is designed to have an acoustic inertance that helps to create the peak frequency response of the transducer 160. In one approach, the passageway 108 may have a length of 1 mm to 12 mm. For instance the passageway 108 may have a length not exceeding 12 mm, not exceeding 10 mm, not exceeding 8 mm, not exceeding 6 mm, not exceeding 4 mm, or not exceeding 2 mm. The length of the passageway 108 may, therefore, be approximately 11 mm, approximately 9 mm, approximately 7 mm, approximately 5 mm, or approximately 3 mm. The dimension of the passageway is preferably smaller than 1 mm, such as smaller than 0.5 mm, smaller than 0.1 mm, smaller than 0.05 mm, or smaller than 0.025 mm. The dimension of the passageway 108, may, therefore, be approximately 0.8 mm, approximately 0.4 mm, approximately, 0.04 mm, or approximately 0.026 mm.

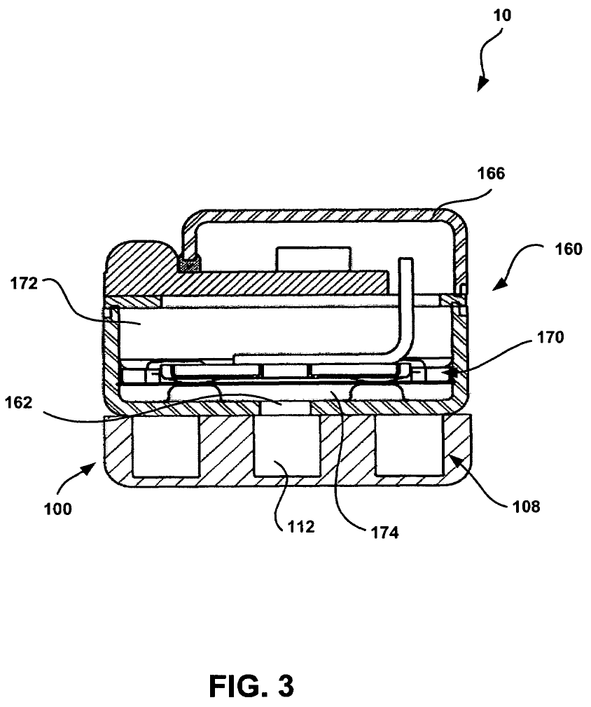

Referring now to FIG. 3, a cross-sectional view of an electroacoustic system 10 is described. The transducer 160 comprises a front volume 174 and a back volume 172 separated by a diaphragm assembly 170 within the housing 168. The front volume 174 is in communication with the acoustic coupling 100 via the sound inlet port 162. As mentioned earlier, the passageway 108 (having an acoustic inertance) is applied to the front volume 174 of the transducer 160 to effectively increase the air mass of the front volume 174, thereby altering the peak frequency response of the transducer 160 to a desired peak frequency value. The peak frequency value preferably does not exceed 10 kHz. For example, the peak frequency value may not exceed 8 kHz, 6 kHz, 4 kHz, or 2 kHz. The peak frequency value may, therefore, be approximately 9 kHz, approximately 7 kHz, approximately 5 kHz, or approximately 3 kHz. The second end 112 of the passageway 108 may completely cover the sound inlet port 162 or may partially cover the sound inlet port 162.

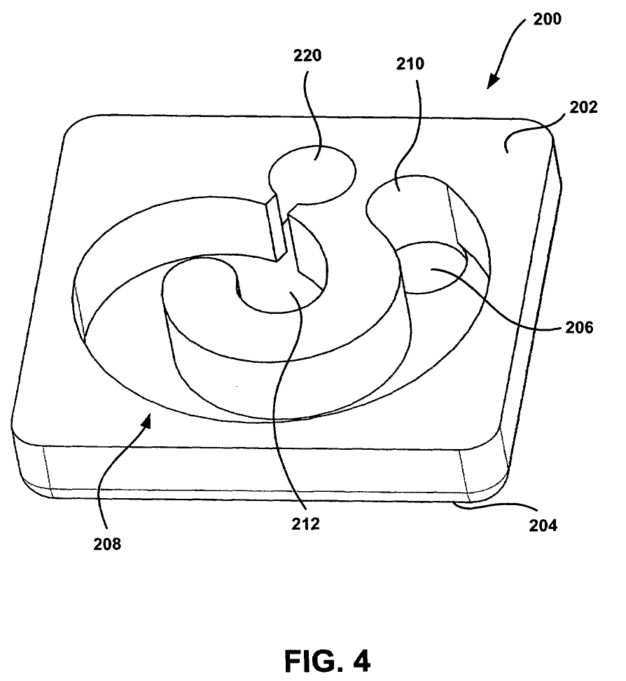

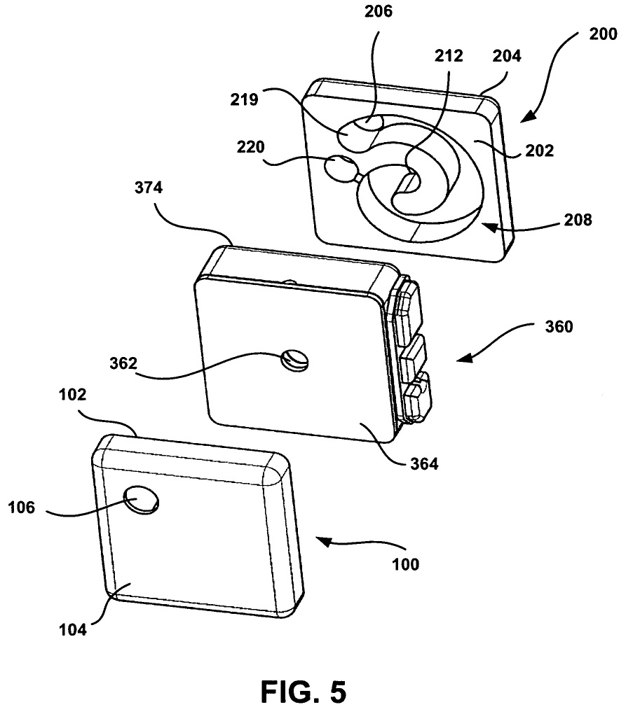

An alternate example of the present approaches is illustrated in FIGS. 4-5. An acoustic coupling 200 is similar to the acoustic coupling 100 illustrated in FIG. 1-3, and like elements are referred to using like reference numerals wherein, for example, 102 and 104 correspond to 202 and 204, respectively. A difference between the acoustic coupling 200 and the acoustic coupling 100 is that a second passageway 220 is formed adjacent the second end 212 of the first passageway 208. The second passageway 208 has a predetermined length and is in acoustic communication with the first passageway 208 to allow at least a portion of the acoustic wave to propagate the second passageway 220. More particularly, the second passageway 220 is adjacent or in close proximity to the sound inlet port 362 so that any unwanted side effects, such as ultrasonic signals, caused by the applications including burglary alarms, car alarms, automatic door openers, or other equipment which uses ultrasonic emitting transducers is dampened. In one embodiment, the second passageway 208 has a length of about a quarter wavelength of the ultrasonic signals to be altered.

As shown in FIG. 5, a transducer 360 includes a first acoustic port 362 and a second acoustic port (not shown), defining a directional microphone. The first acoustic port 362 is formed on a first side 364 and the second acoustic port (not shown) is formed on a second side 374. The acoustic coupling 100 or 200 can be joined to the first and second sides 364, 374. Alternatively, the acoustic coupling 200 is joined to one of the sides 364 or 374 and the acoustic coupling 100 is joined to the opposing side.

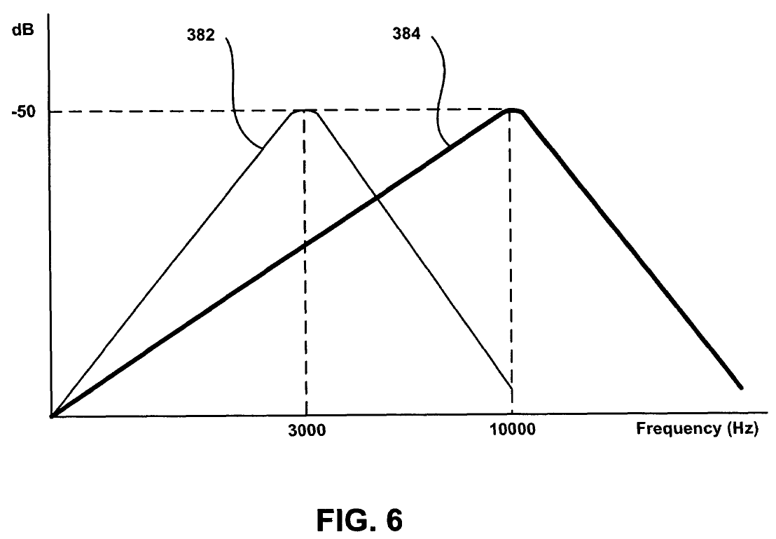

FIG. 6 illustrates the frequency response of a transducer 160 with and without an acoustic coupling 100. The line/curve 382 indicates the frequency response characteristics obtained with the acoustic coupling 100 and the line/curve 384 indicates the frequency response characteristics obtained without the acoustic coupling 100. As shown, the peak frequency of the line/curve 384 is above 10 kHz and the peak frequency of the line/curve 382 is at about 3 kHz, which is substantially lower than the frequency at which the line/curve 384 occurs, due to the acoustic coupling 100 having the acoustic inertance thereby altering a peak frequency level.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An electroacoustic system comprising:
a transducer having a front volume and a back volume, the transducer having a sound inlet port being in communication with the front volume; and
an acoustic coupling joined to the transducer, the acoustic coupling having a passageway comprising a first end and a second end, wherein the second end is acoustically coupled to the sound inlet port for altering the peak frequency response of the transducer.

2. The electroacoustic system of claim 1, wherein the acoustic coupling comprising a first side and a second side, an acoustic port being formed on the second side, wherein the acoustic port is positioned adjacent to the first end of the passageway.

3. The electroacoustic system of claim 1, wherein the passageway is a tube selected from a group consisting of a spiral shape, a zig-zag shape, a curved shape, or combination thereof.

4. The electroacoustic system of claim 1, where the passageway has an acoustic inertance for altering the peak frequency response of the transducer.

5. The electroacoustic system of claim 1, wherein the passageway has a length of about 1 mm to 12 mm.

6. The electroacoustic system of claim 5, wherein the length of the passageway is selected from a group of not exceeding 12 mm, not exceeding 10 mm, not exceeding 8 mm, not exceeding 6 mm, and not exceeding 4 mm.

7. The acoustic system of claim 1, wherein the passageway has a dimension of about 0.01 mm to 1 mm.

8. The electroacoustic system of claim 7, wherein the dimension of the acoustic coupling is selected from a group comprising: smaller than 1 mm, smaller than 0.5 mm, smaller than 0.1 mm, smaller than 0.05 mm, and smaller than 0.025 mm.

9. The electroacoustic system of claim 1, wherein a second passageway is joined to the first passageway.

10. The electroacoustic system of claim 9, wherein the second passageway is adjacent to transducer.

11. The electroacoustic system of claim 9, wherein the second passageway has a length of a quarter wavelength of an ultrasonic frequency.

12. The electroacoustic system of claim 1, wherein a second sound inlet port is in communication with the back volume.

13. The electroacoustic system of claim 12, wherein a second acoustic coupling is joined to the second sound inlet port.

14. The electroacoustic system of claim 13, wherein the second acoustic coupling comprises a second passageway adjacent to the second sound inlet port.

15. The electroacoustic system of claim 1, wherein the sound inlet port is completely covered by the second end of the passageway.

16. The electroacoustic system of claim 1, wherein the sound inlet port is partially covered by the second end of the passageway.

17. The electroacoustic system of claim 1, wherein the transducer is selected from a group comprising at least one of a receiver, a microphone, and a speaker.

18. A microphone comprising:
a sound inlet port;
a first passageway, the first passageway comprising at least one open end and being acoustically coupled to the sound inlet port, wherein the first passageway is dimensioned to attenuate the peak frequency response; and
a second passageway acoustically coupled to the first passageway and defining an acoustic coupling, the second passageway being adjacent to the second sound inlet port, wherein the second passageway is dimensioned to dampen ultrasonic frequency.

19. An electroacoustic system comprising:
a transducer having a front volume and a back volume, the transducer having a sound inlet port being in communication with the front volume; and
an acoustic coupling acoustically coupled to the sound inlet port of the transducer, the acoustic coupling having a passageway comprising a first end and a second end, wherein the passageway is dimensioned to attenuate the peak frequency response.

20. A method of modifying the frequency response of an electroacoustic system comprising:
providing a transducer having a front volume, a back volume and a sound inlet port communicating with the front volume; and
joining an acoustic coupling to the transducer, the acoustic coupling including a passageway having a first end and a second end, wherein the second end is coupled to the sound inlet port for altering the peak frequency response of the transducer.
